(19) United States
(12) Patent Application Publication
(10) Pub. No.: US 2026/0258877 A1
(43) Pub. Date: Sep. 3, 2026

(54) VALVE ASSEMBLIES FOR TRANSMISSIONS AND METHODS AND KITS FOR REWORKING VALVE ASSEMBLIES FOR TRANSMISSIONS

(71) Applicant: Sonnax Transmission Company, Bellows Falls, VT (US)

(72) Inventors: Tanner S. Aberle, Bellows Falls, VT (US); Maura J. Stafford, Warner Robins, GA (US); James A. Dial, Springfield, MT (US)

(73) Assignee: Sonnax Transmission Company, Bellows Falls, VT (US)

(21) Appl. No.: 19/067,520

(22) Filed: Feb. 28, 2025

(51) Int. Cl. F16K 15/02; F16K 17/04

(52) U.S. Cl. CPC F16K 15/026; F16K 17/04

(57) ABSTRACT

A valve assembly for a transmission. The valve assembly includes a valve body having a bore and a plurality of passages fluidly coupled together via the bore. A valve is axially moveable within the bore, wherein moving the valve changes which of the plurality of passages are fluidly coupled via the bore. A collar is positioned within the bore. An end stop retains the valve and the collar within the bore, wherein the collar is positioned axially between the end stop and the valve to prevent the valve from contacting the end stop in use. A spring biases the valve axially away from the end stop.

### FIELD

The present disclosure generally relates to automatic transmissions, and particularly to valves assemblies of automatic transmissions.

### BACKGROUND

Automatic transmissions typically comprise valve assemblies with valve bodies having multiple valves therein for effectuating shifting functions. In certain examples, the transmission specifically includes latch valves, which have latched and de-latched states. By way of example, commercially available transmissions having latch valves within the valve body include models 10R60, 10R80, 10R90, and 10R140 produced by the Ford Motor Company ® of Dearborn, Michigan, and models 10L60,10L80,10L90 produced by General Motors ® of Detroit, Michigan. Other transmissions, including others with latch valves in valve bodies thereof, are also known.

Additional information regarding such transmissions and latch valves is available in U.S. Patent No. 9,353,853, which is incorporated by reference in entirety herein. In certain configurations, the transmission is configured such that in the de-latched states, the latch valves direct a control pressure to a clutch apply circuit. In the latched state, which is entered in response to a control pressure higher than a latch pressure, the latch valve directs a line pressure to the clutch apply circuit. A controller manages the transition from latched to de-latched differently depending upon the transmission input torque and gear state. At high transmission input torque, the controller first reduces the control pressure to rapidly accelerate a spool in the latch valve, and then increases the control pressure to prevent clutch slip. At low torque, the controller reduced the pressure to an intermediate value during the transition and then reduces it again. At moderate torques, the controller reduces the pressure directly to a target pressure in a single step.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure generally relates to a valve assembly for a transmission. The valve assembly includes a valve body having a bore and a plurality of passages fluidly coupled together via the bore. A valve is axially moveable within the bore, wherein moving the valve changes which of the plurality of passages are fluidly coupled via the bore. A collar is positioned within the bore. An end stop retains the valve and the collar within the bore, wherein the collar is positioned axially between the end stop and the valve to prevent the valve from contacting the end stop in use. A spring biases the valve axially away from the end stop.

In certain examples, the collar is axially movable within the bore when the valve moves axially within the bore.

In certain examples, the spring biases the valve away from the end stop via the collar.

In certain examples, the collar extends axially from a first end to a second end, and wherein the valve is at least partially received within a pocket in the first end. In further examples, the spring is at least partially received within a pocket in the second end. In further examples, the pocket in the first end has an inner diameter that is smaller than an inner diameter of the pocket in the second end. In further examples, the first pocket and the second pocket are separated at least partially by a floor therebetween, the spring biasing the collar by providing a force on the floor.

In certain examples, the collar extends axially from a first end to a second end, and wherein the spring is at least partially received within a pocket in the second end.

In certain examples, the collar extends axially from a first end to a second end, and wherein a passage extends through the collar such that fluid may flow from the first end to the second end therethrough.

In certain examples, the bore has an inner diameter, and the collar has an outer diameter that is approximately equal to the inner diameter of the bore.

In certain examples, the collar comprises steel.

In certain examples, the end stop is a retaining clip receivable in a slot that extends into the valve body perpendicularly to a central axis of the bore.

In certain examples, the collar prevents the spring from contacting the valve.

Another aspect according to the present disclosure generally relates to a method for reworking a valve assembly for a transmission, the valve assembly having a valve body with a bore and a plurality of passages fluidly coupled together via the bore, a first valve axially moveable within the bore to change which of the plurality of passages are fluidly coupled via the bore. The method includes removing the first valve, and reducing a length of the first valve and then positioning the first valve back in the bore or obtaining a second valve having a length shorter than length of the first valve and positioning the second valve in the bore. The method further includes positioning a collar in the bore and positioning a spring in the bore. The method further includes installing an end stop so as to retain the spring, the collar, and the valve within the bore, wherein the spring biases the valve away from the end stop, and wherein the collar is positioned axially between the end stop and the valve to prevent the valve from contacting the end stop in use when opposing the spring.

In certain examples, the spring is second spring, and the method further includes removing a first spring from the bore before removing the first valve from the bore, wherein the second spring is shorter than the first spring.

In certain examples, the spring is positioned in the bore after the collar is positioned in the bore.

In certain examples, the collar is positioned such that the spring biases the valve away from the end stop via the collar.

Another aspect according to the present disclosure generally relates to a kit for reworking a valve assembly for a transmission, the valve assembly having a valve body with a bore and a plurality of passages fluidly coupled together via the bore. The kit includes a valve configured to be positioned within the bore and to be axially moveable within the bore to change which of the plurality of passages are fluidly coupled via the bore, and a collar and configured to be positioned within the bore after the valve is positioned therein. A spring is configured to be positioned within the bore. An end stop retains the spring, the collar, and the valve within the bore, wherein the spring biases the valve away from the end stop, and wherein the collar is positioned axially between the end stop and the valve to prevent the valve from contacting the end stop in use.

In certain examples, the collar is positioned to receive the valve at least partially therein.

In certain examples, the collar is positioned to receive the spring at least partially therein.

It should be recognized that the different aspects described throughout this disclosure may be combined in different manners, including those than expressly disclosed in the provided examples, while still constituting an invention accord to the present disclosure. Various other features, objects and advantages of the disclosure will be made apparent from the following description taken together with the drawings.

### BRIEF DESCRIPTION OF THE DRAWINGS

Examples are described with reference to the following drawing figures. The same numbers are used throughout to reference like features and components

FIG. 1 is a sectional side view of an OE valve assembly for a transmission as known in the art.

FIG. 2 is a perspective view of the OE valve assembly of FIG. 1 with a spring removed to show further detail.

FIG. 3 is a sectional perspective view of a valve assembly according to the present disclosure.

FIG. 4 is an exploded close-up, sectional, perspective view of a valve and a collar from the valve assembly of FIG. 3.

FIG. 5 is a perspective view depicting reuse of a damaged OE valve according to the present disclosure for use in a valve assembly such as that of FIG. 3.

FIG. 6 is a flow chart for one method of reworking an OE valve assembly according to the present disclosure to provide a valve assembly, such as that of FIG. 3.

FIG. 7 is an exploded perspective view depicting part of another embodiment of a valve assembly according to the present disclosure.

FIG. 8 is a sectional perspective view of another embodiment of a valve assembly according to the present disclosure.

### DETAILED DESCRIPTION

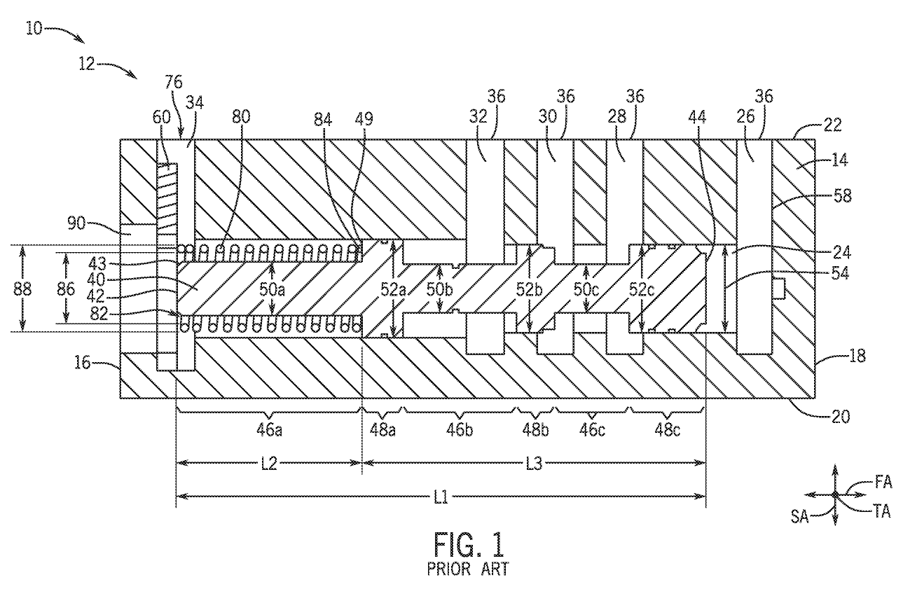

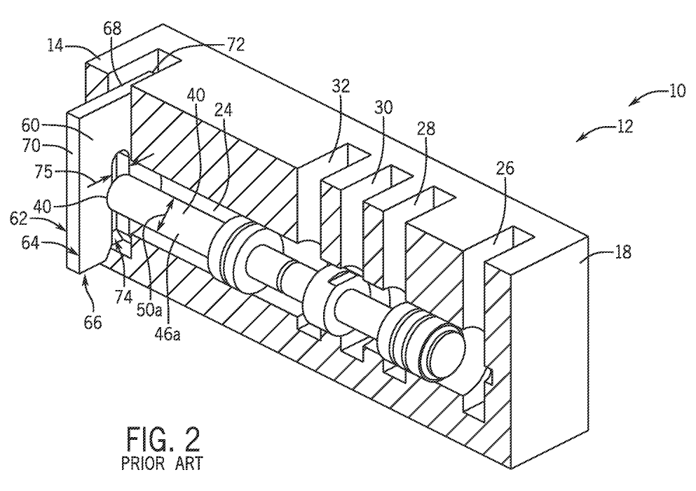

The present disclosure generally relates to transmissions, and particularly to valve assemblies having valves within valve bodies thereof. As discussed above, transmissions, including transmission with latch valves therein, are conventionally known and used within the automotive space. Ford ® models 10R60, 10R80, 10R90, and GM ® models 10L60,10L80,10L90 transmissions utilize a set of four latch valves in the valve body. Ford ® model 10R140 transmissions utilize a set of two latch valves in the valve body. An example of a transmission 10 like those known in the art, and particularly the valve assembly 12 thereof, is shown in FIGS. 1-2. Since these transmissions 10 are known in the art, only the valve assembly 12 is discussed for the purpose of brevity.

The OE valve assembly 12 of FIGS. 1-2 includes an OE valve body 14 that extends from a first end 16 to a second end 18 along a first axis FA and from a third end 20 to a fourth end 22 along a second axis SA, being shown in sectional view through a third axis TA. A bore 24 extends through the OE valve body 14 along the first axis FA. A plurality of passages extend outwardly from the bore 24, here as an exhaust outlet passage 26 (e.g., for exhausting any line pressure that makes it past the spools, whereby the exhausting fluid meets up with other latch valve exhaust ports and travels to a different valve or accumulator assembly to perform a different function in the valve body, a line passage 28 (e.g., line pressure that comes directly from the pump, whereby when the valve shifts to the left in the orientation shown, the inlet line pressure will then travel to the clutch pack that the latch valve is assigned to and will engage the clutch to shift accordingly), an apply clutch passage 30 (e.g., allows line fluid to travel to a certain clutch to be engaged), a regulator valve inlet passage 32 (e.g., receives pressure from a control shift solenoid, whereby fluid coming into this passage is responsible for stroking the valve to the left, allowing line pressure to travel to the appropriate clutch pack to engage it), and a second exhaust passage 34 (e.g., allows any fluid to escape and exhaust pack to a catch pan, which is then recirculated throughout the system by the pump as line pressure). These passages may also be referred to as connecting the bore 24 to different ports 36 associated with the functions and connections described above. It should be recognized that absent anything in the bore 24, the passages are fluidly connected to each other via the bore 24.

The valve assembly 12 further includes an OE valve 40 that extends from a first end 42 to a second end 44 a first length L1 along a first axis parallel to the first axis FA of the OE valve body 14. The first end 42 has a chamfer 43 to prevent the first end 42 from catching on the spring 80, which is discussed further below. The OE valve 40 includes multiple stems 46a, 46b, 46c and multiple lands 48a, 48b, 48c. For convenience in later description, the first length L1 of the OE valve 40 may be subdivided into a second length L2 from the first end 42 to the face 49 of the land 48a, and a third length L3 from the face 49 of the land 48a to the second end 44. Other features are provided with the stems and lands, but are not discussed herein for brevity as these features are known. The stems 46a-46c have diameters 50a-50c and the lands have diameters 52a-52c, which for simplicity are discussed as being uniform but, as shown, may vary. The diameters 52a-52c of the lands 48a-48c generally correspond with an inner diameter 54 of the valve bore 24 such that fluid cannot flow axially past the lands 48a-48c within the valve bore 24. In contrast, the diameters 50a-50c of the stems 46a-46c are less than those of the lands 48a-48c, allowing fluid to flow between the lands 48a-48c around the stems 46a-46c.

The OE valve 40 is axially moveable within the valve bore 24 to change axial positions of the lands 48a-48c relative to the passages extending away from the valve bore 24. By virtue of the diameters discussed above, the axial position of the OE valve 40 (relative to the bore 24 and its passages) controls which of the plurality of passages are fluidly coupled to each other through the bore 24. For example, as shown in FIG. 1, the line passage 28 and the apply clutch passage 30 are fluidly coupled via the valve bore 24, specifically by allowing fluid flow along the stem 46c between the land 48b and the land 48c. However, the land 48b prevents fluid flow with the regulator valve inlet passage 32 and the land 48c prevents fluid flow with the exhaust outlet passage 26. It should be recognized that if the OE valve 40 were axially moved such that the land 48b is at least partially into or beyond the apply clutch passage 30, fluid could then flow between the regulator valve inlet passage 32 and the apply clutch passage 30, but no longer between the line passage 28 and the apply clutch passage 30 (being blocked by the land 48b).

Movement of the OE valve 40 is axially limited towards the second end 18 of the valve body 14 by contact between the second end 44 of the OE valve 40 and an end 58 of the bore 24. In contrast, movement of the OE valve 40 is axially limited towards the first end 16 of the valve body 14 by contact between the first end 42 of the OE valve 40 and an end stop, here an OE retaining clip 60, positionable to retain the OE valve 40 within the bore 24. The OE retaining clip 60 extends from a first end 62 to a second end 64, from a third end 66 to a fourth end 68, and from a fifth end 70 to a sixth end 72. A slot or exhaust gap 74 extends from the third end 66 towards the fourth end 68. The exhaust gap 74 having a width 75 allows any fluid that leaks past the land 48a to escape and avoid a buildup of pressure between the OE retaining clip 60 and the land 48a, returning to the reservoir or sump.

Returning to FIG. 1, the OE retaining clip 60 is received within a slot 76 that extends approximately perpendicular to the bore 24. The slot 76 may be larger than a thickness of the OE retaining clip 60 between the first side 62 and the second side 64 thereof. A spring 80 is positioned axially about the stem 46a and extends from a first end 82 to a second end 84. The spring 80 has an inner diameter 86 that is greater than the diameter 50a of the stem 46a such that the stem 46a may extend therein. The spring 80 has an outer diameter 88 that is less than the inner diameter 54 of the bore 24, allowing the spring 80 to be positioned therein.

The spring 80 biases the OE valve 40 axially away from the OE retaining clip 60, particularly by contact between the first end 82 and the OE retaining clip 60, and between the second end 84 and a contact face 49 of the land 48a. It should be recognized that fluid pressure from one of the passages opposes the spring 80 to axially move the OE valve 40 until first end 42 of the OE valve 40 contacts and is limited by the OE retaining clip 60. It should further be recognized that the OE retaining clip 60 retains the OE valve 40 within the bore 24, with the OE valve 40 being removeable therefrom by removing the OE retaining clip 60 via the slot 76, then axially sliding the OE valve 40 out via an opening 90 at the first end 16 of the valve body 14.

Through experimentation and development, the present inventors have recognized problems with OE valve assemblies known in the art, such as the OE valve assembly of FIG. 1. Among these is that the stem 46a (also referred to as the spring stem) of the OE valve 40 that abuts the OE retaining clip 60 becomes damaged over time. In particular, damage occurs as the first end 42 of the OE valve 40 and the exhaust gap 74 (also referred to as an exhaust gap) in the OE retaining clip 40 repeatedly contact one another during the stroking motion of the valve. The exhaust gap 74 in the OE retaining clip 60, which measures approximately 0.11” in width, allows any fluid that bypasses the critical spool of the valve to exhaust back to the sump instead of building up pressure in the bore where the spring resides, as discussed above. The stem 46a of the OE valve 40 has a diameter 50a of approximately Ø 0.18” – Ø 0.20” across the various known transmissions. However, the chamfer 43 at the first end 42 of the OE valve 40, which is approximately 0.02” x 45°, reduces the diameter at the first end 42 to approximately Ø 0.14” - 0.16”, which as discussed above is provided to reduce the risk of spring 80 and stem 46a becoming entangled. Therefore, there is only 0.03” - 0.05” diametrically, or 0.015” - 0.025” radially, of stem 46a material meeting outside the width 75 of the exhaust gap 74.

As a result, when pressure enters the regulator valve inlet passage 32 at roughly 100 psi, the aluminum OE valve 40 is stroked towards the OE retaining clip 60 and the flat face at the first end 42 of the OE valve 40 (Ø 0.14” – Ø 0.16”) contacts the exhaust gap 74 in the OE retaining clip 60 (0.11”) under a great force. A combination of this minimal material clearance, repetitive stroking, high force/pressure, and difference in materials (e.g., a steel OE retaining clip 60 and an aluminum OE valve 40) is causing raised edges, burrs, and damage on the stem 46a as it tries to force its way through the exhaust gap 74 in the OE retaining clip 60. This damage to the valve stem can lead to spring entanglement, improper stroking of the valve, and future bore wear. These complications can lead to failure codes and burnt clutches down the road due to improper valve function.

In view of these problems, the present inventors have developed solutions that can advantageously be implemented for future valve body assemblies, or functional with existing valve bodies 14 and bores 24 for repairs and/or preventative maintenance to prevent future wear and complication. As will become apparent, the solutions are cost effective, efficient to install, and retain the same operation and hydraulic function of the original OE configuration.

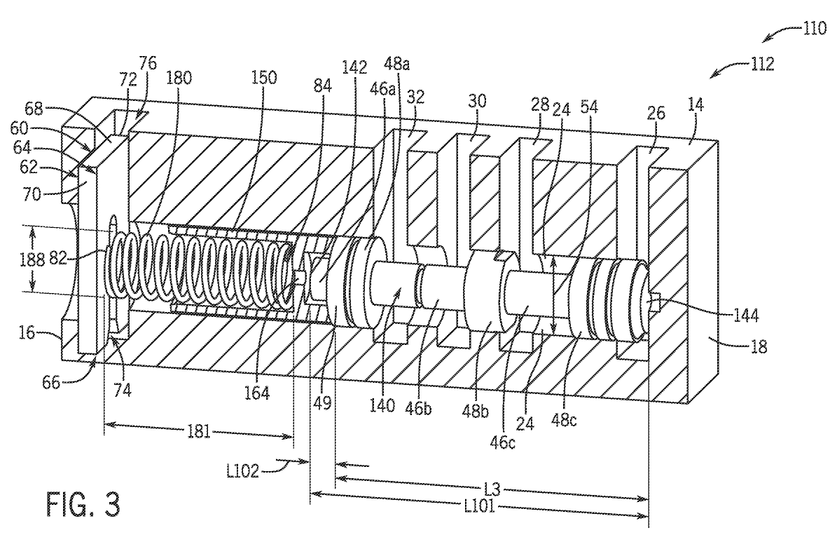

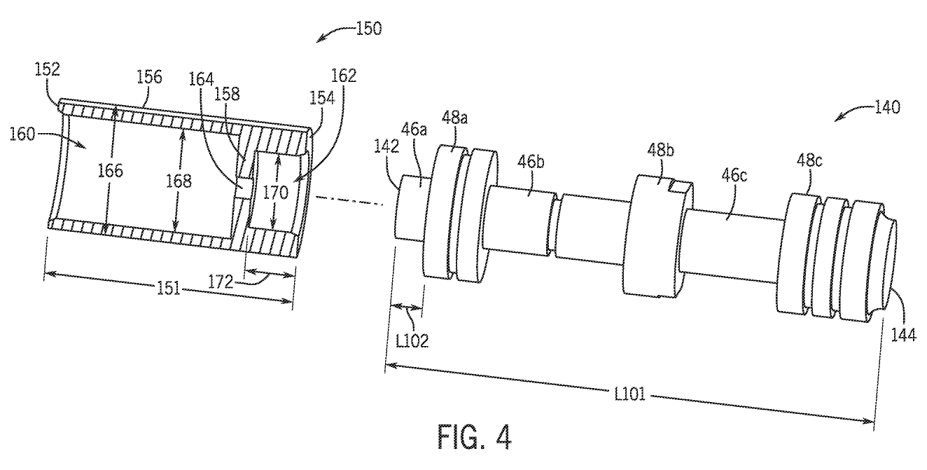

The present inventors have recognized that these problems can be avoided in multiple ways, including increasing the area in which a valve contacts the retaining clip, changing where the valve contacts the retaining clip (e.g., farther from the exhaust gap 74), or reconfiguring the valve assembly such that the valve does not stroke against the retaining clip at all. FIGS. 3-4 depict one embodiment of a valve assembly 112 according to the present disclosure, which advantageously may utilize the same OE valve body 14 and OE retaining clip 60 known in the art (and, with modifications, reuse the OE valve as discussed further below). Parts that may be reused from known OE components are not discussed in further detail for brevity, and may also be shown with the same reference numbers discussed above. Likewise, similar part numbers are used where possible to describe similar elements, for example being increased by 100 for the new embodiment according to the present disclosure.

In the embodiment shown, the valve assembly 112 includes a valve 140 that extends from a first end 142 to a second end 144. It should be noted that where a given element could be the same as described above for the OE valve assembly 112, like reference numbers may be used for brevity. For example, the valve 140 may have the same stems 46b, 46c and the same lands 48a, 48b, 48c as the OE valve 40 above, which as will become apparent provides the same hydraulic operation as the OE valve 40 above. In other words, the valve 140 may be the same as or similar to the OE valve 40 from the face 49 of the land 48a to the second end 144, including having the same third length L3 therebetween. However, a first length L101 between the first end 142 and the second end 144 is shorter than the first length L1 of the OE valve 40, which here also means that a second length L102 between the first end and the face 49 of the land 48a is less than the second length L2 for the OE valve 40. This second length L102 can be zero, but for the valve 140 shown is non-zero to help engage with other elements discussed further below.

The present inventors have recognized that if the valve assembly 112 is to function in the same manner as the OE valve 40 in controlling fluid connections through the bore 24, the valve 140 must be limited such that when fully stroked toward the first side 16 of the OE valve body 14, the face 49 of the land 48a is the same distance from the retaining clip 60 as with the OE valve 40, or in other words approximately equal to the second length L2 shown in FIG. 1.

To this end, the valve assembly 112 further includes a collar 150 configured to be positioned in the bore 24 along with the valve 140. In certain embodiments, the collar 150 comprises steel for greater durability over the aluminum of the OE valve 40 when contacting the OE retaining clip 60. The collar 150 extends a length 151 between a first end 152 and a second end 154, here having a cylindrical outer surface 156 (shown in sectional view to show details inside the collar 150). A partial floor 158 extends radially inwardly, defining the base of a first pocket 160 axially inwardly from the first end 152 and the base of a second pocket 162 axially inwardly form the from the second end 154. A passage or opening 164 extends through the floor 158 such that fluid may be exhausted therethrough. The cylindrical outer surface 156 has an outer diameter 166, which here is consistent from the first end 152 to the second end 154. The outer diameter 166 is approximately equal to the inner diameter 54 of the bore 24, and also approximately equal to the diameter 52a of the land 48a. However, other configurations are contemplated. The first pocket 160 has a first inner diameter 168 that is larger than a second inner diameter 170 of the second pocket 162. However, other configurations are contemplated.

With continued reference to FIGS. 3-4, the second inner diameter 170 of the second pocket 162 in the collar 150 is at least as large as the diameter 50a of the stem 46a, allowing the first end 142 of the valve 40 to be at least partially positioned within the second pocket 162. This helps align the collar 150 and the valve 140, and retain coaxial alignment during the stroking process. As shown in FIG. 3, the second pocket 162 has a depth 172 that is greater than the second length L102 of the valve 140. This ensures that the second end 154 of the collar 150 seats against the face 49 of the land 48a without interference from the stem 46a. This also prevents the first end 142 of the valve 140 from blocking the opening 164 through the floor 158 and restricting fluid communication therethrough. The length 151 of the collar 150 is such that when the collar 150 abuts the valve 140, the combined length is approximately equal to the first length L1 of the OE valve assembly 12 to retain the same operational characteristics.

The valve assembly 112 further includes a spring 180 that, like the OE spring 80, biases the valve 140 axially away from the OE retaining clip 60. Here, the spring 180 is positioned between the OE retaining clip 60 and the floor 158 of the collar 150 such that when the spring 180 provides a force against the floor 158, the force is transferred through the collar 150 to the valve 140. In contrast to the OE spring 80, the spring 180 has a length 181 between its first end 82 and second end 84 that is less than that of the OE spring 80. This reduction in length 181 accommodates for the fact that the spring 180 does not extend entirely to the face 49 of the land 48a, but rather to the floor 158 in the first pocket 160 of the collar 150. The spring 180 shown also has a reduced outer diameter 188, relative to the OE spring 80, to allow the spring 180 to fit within the first pocket 160 of the collar 150. While other configurations are contemplated, the spring 180 being positioned at least partially within the first pocket 160 of the collar 150 assists with alignment and retention of the components throughout the stroking process.

In this manner, it should be recognized that the biasing from the spring 180 provides that the collar 150 and the valve 140 move axially together as one. The collar 150 has a greater outer diameter 166 than the diameter 50a of the stem 46a of the valve 140, and thus provides a wider base of contact with the OE retaining clip 60 to avoid damage caused by engaging the exhaust gap 74. The collar 150 also being made of a harder and/or otherwise more robust material than the valve 140, such as steel, increases the durability and longevity further.

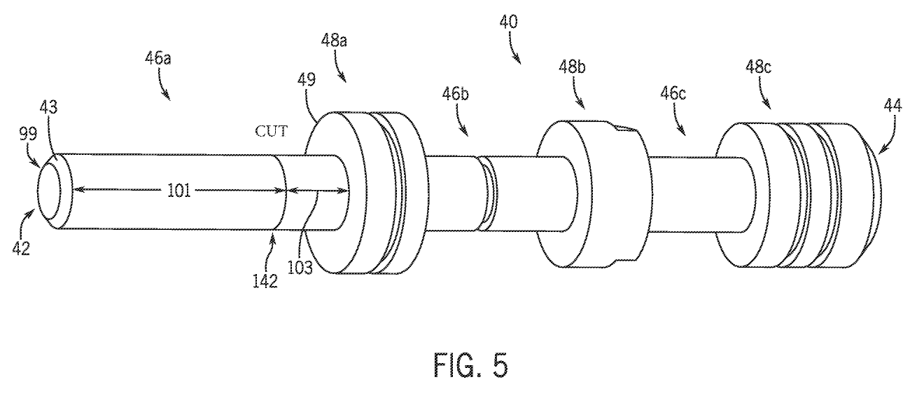

The valve 140 may be produced in the manner described above as a new component, or may be created by modifying the OE valve 40. FIG. 5 shows how a damaged OE valve 40 (damage indicated as 99, which as stated above can include burrs and other deformities) can be modified for use in a valve assembly 140 of FIGS. 3-4. In particular, a predetermined length 101 may be cut from the damaged first end 42 such that a remaining length 103 is retained between the new first end 142 and the face 49 of the land 48a. An acceptable range of remaining lengths 103 may be provided to the modifying technician such that the first end 142 will not bottom out in the second pocket 162 of the collar 150, as discussed above, but in certain embodiments is still long enough (e.g., Ø 0.18” – Ø 0.20”) to provide some extension into the collar 150. In other embodiments, the entire stem 46a may be removed.

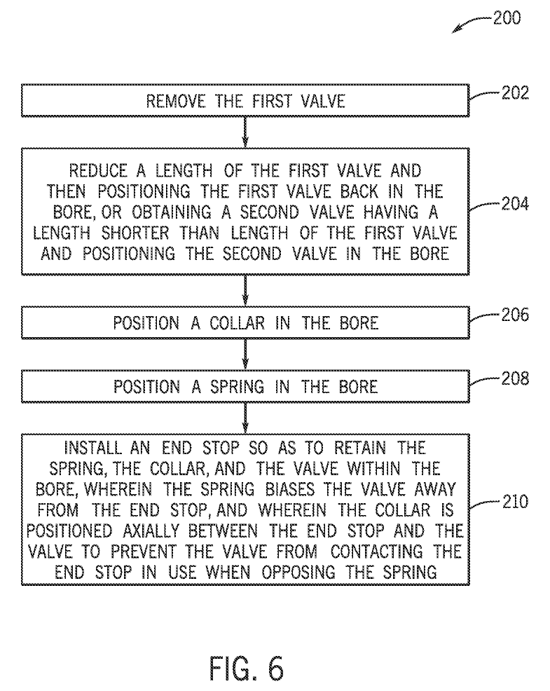

As discussed above, the valve assembly 140 provides for simple installation and even upgrading or repair with existing OE valve bodies 112. With concurrent reference to FIGS. 1 and 3, FIG. 6 shows one method 200 for reworking an OE valve assembly 12 for a transmission to create a new valve assembly, such as the valve assembly 112 of FIGS. 3-4. As discussed above, the valve assembly has a valve body that may be an OE valve body 14 as known in the art, which has a bore 24 and a plurality of passages fluidly coupled together via the bore 24. Afirst valve (e.g., OE valve 40) is axially moveable within the bore to change which of the plurality of passages are fluidly coupled via the bore 24. Step 202 provides for removing the first valve from the bore, such as by first removing an OE retaining clip 60. Step 204 provides for either reducing a length of the first valve (e.g., see FIG. 5) and then positioning the first valve back in the bore, or obtaining a second valve (e.g., the valve 140 of FIG. 3) having a length shorter than length of the first valve and positioning the second valve in the bore. Step 206 provides for positioning a collar in the bore, and in step 208 positioning a spring in the bore. Step 208 provides for installing an end stop (e.g., the OE retaining clip 60 or something else) so as to retain the spring, the collar, and the valve within the bore, wherein the spring biases the valve away from the end stop, and wherein the collar is positioned axially between the end stop and the valve to prevent the valve from contacting the end stop in use when opposing the spring.

In certain embodiments, the spring being installed is different than another spring that is first removed from the bore.

In certain embodiments, the spring is positioned in the bore in step 208 only after the collar is positioned in the bore in step 206.

In certain embodiments, the collar is positioned in step 206 such that the spring when positioned in step 208 biases the valve away from the end stop via the collar.

The present disclosure also contemplates a kit for reworking OE valve assemblies known in the art, such as via the method 200 described above. By way of example, such a kit may include a valve such as the valve 140, the collar 150, and the spring 180 of FIG. 3 to produce a reworked, or new valve assembly (e.g., valve assembly 112). All other components in the reworked or new valve assembly may be reused from the original OE valve assembly, such as the valve body and the end stop (or retaining clip). The collar may be configured to be positioned to receive the valve at least partially therein. The collar may also or alternatively be configured to be positioned to receive the spring at least partially therein.

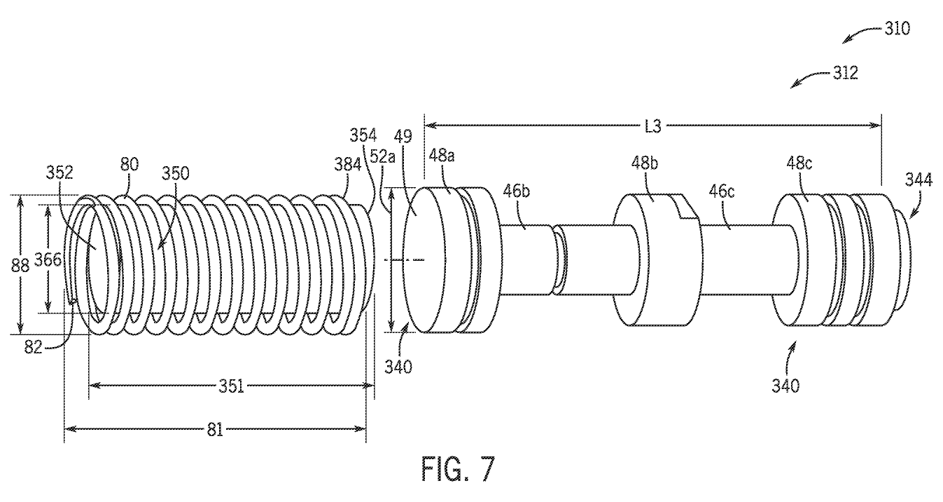

FIG. 7 shows another embodiment of a valve assembly 312 according to the present disclosure. The same OE valve body 14 and OE retaining clip 60 of FIG. 1 may again be used and thus for clarity is not shown. In certain embodiments, the OE spring 80 may also be reused. In place of the OE valve 40, the valve assembly 312 includes a new valve 340 and a collar 350. To ensure the same functionality as the OE valve 40, the valve 340 may be the same from the face 49 of the land 48a to the second end 344 of the valve 340, also having a same length L3 therebetween as the OE valve 40. However, the valve 340 does not have a stem extending from the land 48a in an opposite direction of the stem 46b. Rather, the face 49 of the land 48a is the first end 342 of the valve 340. To prevent the valve 340 from contacting the OE retaining clip, the collar 350 is positioned axially between the valve 340 and the OE retaining clip in the bore. The collar 350 extends a length 351 from a first end 352 to a second end 354. The collar 350 is shown to be a solid cylindrical prism, but other configurations are contemplated. The collar 350 has a diameter 366 which is small enough to fit within an inner diameter of the spring 80, while the outer diameter 88 of the spring 80 small enough to fit within the bore.

The diameter 366 is in certain embodiments larger than the diameter 50a of the stem 46a of the OE valve 40, providing greater surface area for contacting the OE retaining clip and thus reducing damage. Damage may also or alternatively be reduced by the collar 350 comprising steel or another material more robust than the valve 340, which as with the OE valve 40 may be made of aluminum.

The length 351 of the collar 350 is approximately the same length L2 of the stem 46a from the OE valve 40 (see FIG. 1). This provides that the combination of the length 351 of the collar 350 and the length L3 between the face 49 of the of the valve 340 and the second end 344 thereof are approximately equal to the length L1 of the OE valve 40, retaining the same functionality of the OE valve.

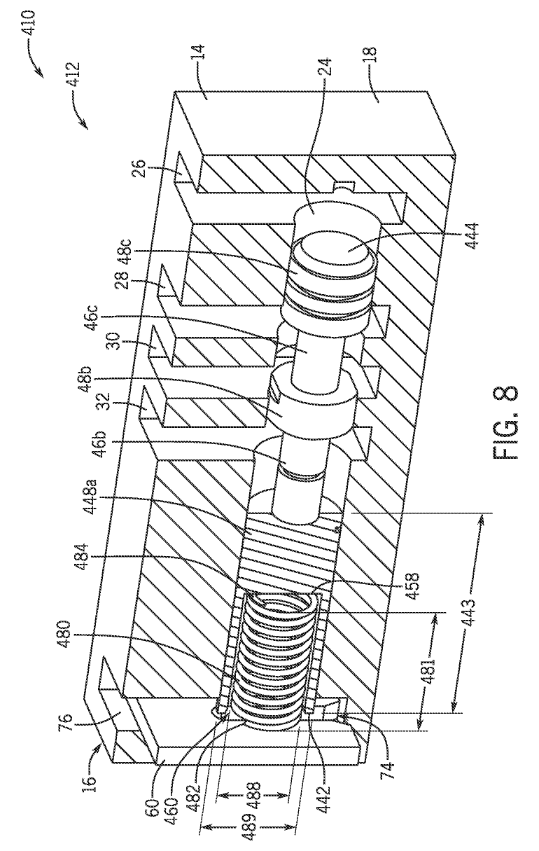

A further embodiment of a valve assembly 412 according to the present disclosure is shown in FIG. 8. Like that of FIG. 7, the same OE valve body 14, OE retaining clip 60 of FIG. 1 may again be used. In certain embodiments, the OE spring 80 may also be reused, though in the case of FIG. 8 the spring 480 has a shorter length 481 between the first end 482 and the second end 484 thereof.

The valve 440 may be the same as the OE valve 40 from the stem 46b to the second end 444. However, the land 448a that provides the functionality of the land 48a in selectively controlling the fluid flow through the bore 24 now extends forwardly to the first end 442 of the valve 40 in place of the stem 46a of the OE valve 40. In other words, a length 443 of the land 448a is approximately equal to the combined lengths of the stem 46a and the land 48a of the OE valve 40 (FIG. 1). Functionally, the valve 440 works in a similar manner as the valve 140 of FIG. 3, which benefits from the first end 442 having a larger diameter 489 than the diameter 50a of the stem 46a (FIG. 1) of the OE valve 40, and thus avoiding damage. Like the valve 140 of FIG. 3, a pocket 460 extends axially inwardly from the first end 442 of the valve 440, extending a distance to a floor 458 at the base of the pocket 460. The pocket 460 has an inner diameter that is at least a large as the outer diameter 488 of the spring 480 such that the spring 480 may be at least partially received therein. The outer diameter 488 of the spring 480 may be the same as that of the spring 80 (FIG. 1), or different, depending on the dimensions of the bore 24 and the valve 440.

In use, the valve 440 shuttles in the same manner as the OE valve 40 of FIG. 1, but avoids the damage and consequences identified by the present inventors by increasing the contact surface of the valve 440 with the OE retaining clip 60, and also moving these contact surfaces farther radially away from the exhaust gap 74 in the OE retaining clip 60.

In this manner, the various embodiments according to the present disclosure provide a more robust design for valve assemblies of transmissions that can advantageously be used for new transmission designs, upgrades or preventative maintenance of existing transmission devices (and with only minimal part changes), and also repair of existing transmissions having damaged valves.

It should be recognized that while the examples above related to latch valves for transmissions, the systems, devices, kits, and methods according to the present disclosure also apply to other types of valves (including non-latching solenoid valves), and also non-transmission applications.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. A valve assembly for a transmission, the valve assembly comprising:
a valve body having a bore and a plurality of passages fluidly coupled together via the bore;
a valve axially moveable within the bore, wherein moving the valve changes which of the plurality of passages are fluidly coupled via the bore;
a collar positioned within the bore;
an end stop that retains the valve and the collar within the bore, wherein the collar is positioned axially between the end stop and the valve to prevent the valve from contacting the end stop in use; and
a spring that biases the valve axially away from the end stop.

2. The valve according to claim 1, wherein the collar is axially movable within the bore when the valve moves axially within the bore.

3. The valve according to claim 1, wherein the spring biases the valve away from the end stop via the collar.

4. The valve according to claim 1, wherein the collar extends axially from a first end to a second end, and wherein the valve is at least partially received within a pocket in the first end.

5. The valve according to claim 4, wherein the spring is at least partially received within a pocket in the second end.

6. The valve according to claim 5, wherein the pocket in the first end has an inner diameter that is smaller than an inner diameter of the pocket in the second end.

7. The valve according to claim 5, wherein the first pocket and the second pocket are separated at least partially by a floor therebetween, the spring biasing the collar by providing a force on the floor.

8. The valve according to claim 1, wherein the collar extends axially from a first end to a second end, and wherein the spring is at least partially received within a pocket in the second end.

9. The valve according to claim 1, wherein the collar extends axially from a first end to a second end, and wherein a passage extends through the collar such that fluid may flow from the first end to the second end therethrough.

10. The valve according to claim 1, wherein the bore has an inner diameter, and wherein the collar has an outer diameter that is approximately equal to the inner diameter of the bore.

11. The valve according to claim 1, wherein the collar comprises steel.

12. The valve according to claim 1, wherein the end stop is a retaining clip receivable in a slot that extends into the valve body perpendicularly to a central axis of the bore.

13. The valve according to claim 1, wherein the collar prevents the spring from contacting the valve.

14. A method for reworking a valve assembly for a transmission, the valve assembly having a valve body with a bore and a plurality of passages fluidly coupled together via the bore, a first valve axially moveable within the bore to change which of the plurality of passages are fluidly coupled via the bore, the method comprising:
removing the first valve;
reducing a length of the first valve and then positioning the first valve back in the bore, or obtaining a second valve having a length shorter than length of the first valve and positioning the second valve in the bore;
positioning a collar in the bore;
positioning a spring in the bore; and
installing an end stop so as to retain the spring, the collar, and the valve within the bore, wherein the spring biases the valve away from the end stop, and wherein the collar is positioned axially between the end stop and the valve to prevent the valve from contacting the end stop in use when opposing the spring.

15. The method according to claim 14, wherein the spring is second spring, further comprising removing a first spring from the bore before removing the first valve from the bore, wherein the second spring is shorter than the first spring.

16. The method according to claim 14, wherein the spring is positioned in the bore after the collar is positioned in the bore.

17. The method according to claim 14, wherein the collar is positioned such that the spring biases the valve away from the end stop via the collar.

18. A kit for reworking a valve assembly for a transmission, the valve assembly having a valve body with a bore and a plurality of passages fluidly coupled together via the bore, the kit comprising:
a valve configured to be positioned within the bore and to be axially moveable within the bore to change which of the plurality of passages are fluidly coupled via the bore;
a collar and configured to be positioned within the bore after the valve is positioned therein;
a spring configured to be positioned within the bore; and
an end stop configured to retain the spring, the collar, and the valve within the bore, wherein the spring biases the valve away from the end stop, and wherein the collar is positioned axially between the end stop and the valve to prevent the valve from contacting the end stop in use.

19. The kit according to claim 18, wherein the collar is positioned to receive the valve at least partially therein.

20. The kit according to claim 18, wherein the collar is positioned to receive the spring at least partially therein.
